(19) United States
(12) Patent Application Publication
(10) Pub. No.: US 2005/0271538 A1
(43) Pub. Date: Dec. 8, 2005

(54) Gear for use in a gear pump

(75) Inventors: Mikhail Allan Knighton, Sweet Home, OR (US); Matthew Alan Warren, Keizer, OR (US)

Correspondence Address: STOEL RIVES LLP, 900 SW FIFTH AVENUE, SUITE 2600, PORTLAND, OR, 97204-1268, US

(73) Assignee: Entek Manufacturing, Inc.

(21) Appl. No.: 11/145,371

(22) Filed: Jun. 3, 2005

Related U.S. Application Data
(60) Provisional application No. 60/576,961, filed on Jun. 4, 2004.

(51) Int. Cl. F04C 18/00; F03C 2/00; F01C 1/24; F04C 2/00; F01C 21/06

(52) U.S. Cl. 418/206.1; 418/206.5

(57) ABSTRACT

A gear for use in a gear pump having intermeshing gear teeth includes indentations formed on one or both of first and second sides of at least one of the multiple gear teeth of the gear. Each of the indentations is of sufficient size to allow material to flow into the indentation during counter-rotation of the intermeshing gears. Material processed by the gear pump and otherwise trapped between the intermeshing gears flows into the indentation, which forms a channel that connects to the outlet chamber. The otherwise trapped material flows into the outlet chamber. The gear having gear tooth indentations decreases the amount of material trapped between the intermeshing gears and thereby decreases the amount of material squeezed out the sides of the gears and improves material flow within the gear pump.

### RELATED APPLICATION

This application claims the benefit under 35 U.S.C. § 119(e) of U.S. Provisional Patent Application No. 60/576,961, filed Jun. 4, 2004.

### TECHNICAL FIELD

An improved gear for use in a gear pump includes vented gear teeth that improve material flow within the gear pump.

### BACKGROUND OF THE INVENTION

FIGS. 1-3 show respective isometric, side elevation, and front elevation views of a dual-extended, left-handed, external-type spur gear pump, which is one exemplary type of gear pump. FIGS. 4 and 5 are cross-sectional views of the gear pump of FIGS. 1-3 taken along lines 4-4 of FIG. 3 and lines 5-5 of FIG. 1, respectively. FIG. 6 is an isometric view of a prior art gear suitable for use in the gear pump of FIGS. 1-3.

As shown in FIGS. 1-6, a gear pump 2 includes a gear chamber 4 defined by first (front) and second (rear) side plates 6 and 8 fitted to a housing 10. An upper gear 12ᵤ and a lower gear 12ₗ are each housed in gear chamber 4. Upper gear 12ᵤ includes a shaft portion 14ᵤ having opposite first and second ends 16ᵤ and 18ᵤ and a longitudinal axis 20ᵤ about which shaft portion 14ᵤ rotates. Similarly, lower gear 12ᵢ includes a shaft portion 14ₗ having opposite first and second ends 16ₗ and 18ₗ and a longitudinal axis 20ₗ about which shaft portion 14ₗ rotates. Each shaft portion 14ᵤ and 14ₗ may be stepped, as shown in FIGS. 1-6. Ends 16ᵤ and 18ᵤ of shaft portion 14ᵤ and ends 16ₗ and 18ₗ of shaft portion 14 pass through holes formed in side plates 6 and 8, as shown in FIGS. 2 and 4. Each hole in side plates 6 and 8 receives a different one of four bearing assemblies 22, in which upper and lower gears 12ᵤ and 12ₗ are journalled for rotation. The holes in side plates 6 and 8 are placed so that the gear teeth of upper gear 12ᵤ and lower gear 12ₗ mesh as they counter-rotate about parallel longitudinal axes 20ᵤ and 20ₗ, respectively.

As shown in FIG. 6, elongated gear teeth 24 are positioned between first and second ends 16 and 18 and are angularly spaced around each shaft portion 14. Gear teeth 24 are supported on shaft portion 14 by an annular base 23 and extend radially outwardly from longitudinal axis 20. Each gear tooth 24 has a length 26 measured radially from annular base 23 of shaft portion 14. Gear teeth 24 may be machined as an integral part of or may be pressed or welded onto shaft portion 14. Each gear tooth 24 has a first (leading) side 28 and a second (trailing) side 30 that form opposite side surfaces of gear tooth 24 and extend from annular base 23 of shaft portion 14 and converge to form gear tooth tip 32.

FIG. 5 shows a cross-sectional view of exemplary gear pump 2. As shown in FIG. 5, tips 32 of gear teeth 24 abut with sufficient clearance to allow rotational movement relative to an inner surface 34 of gear chamber 4 during operation of gear pump 2, thereby forming voids 36 between adjacent gear teeth 24. Upper gear 12ᵤ is the driving gear and is rotatably driven by a power source (not shown), such as a motor. Upper gear 12ᵤ preferably rotates in a clockwise direction, as shown by directional arrow 42. Lower gear 12ₗ is the driven gear and preferably rotates in a counterclockwise direction, as shown by directional arrow 44. Gear teeth 24ₗ of lower gear 12ₗ intermesh with gear teeth 24ᵤ of upper gear 12ᵤ to form an intermeshing region 38 in gear chamber 4. The intermeshing of upper and lower gears 12ᵤ and 12ₗ and the clockwise rotation 42 of upper gear 12ᵤ causes lower gear 12ₗ to rotate in a counterclockwise direction 44. Where gear teeth 24ₗ intermesh with gear teeth 24ᵤ, first (leading) side 26 of upper gear tooth 24ᵤ contacts second (trailing) side 30 of lower gear tooth 24ₗ. As is known to those of skill in the art, gear pump 2 can be arranged in various alternative embodiments, in which, for example, lower gear 12ₗ is the driving gear and upper gear 12ᵤ is the driven gear or upper gear 12ᵤ rotates in a counterclockwise direction and lower gear 12ₗ rotates in a clockwise direction.

As shown in FIG. 5, an inlet chamber 46 and an outlet chamber 48 are provided on opposite sides of intermeshing region 38. Inlet chamber 46 is connected to an inlet channel 50, and outlet chamber 48 is connected to an outlet channel 52 and a discharge portion (not shown) located outside of housing 10. The rotation of upper and lower gears 12ᵤ and 12ₗ and the intermeshing of gear teeth 24 create partial vacuum pressure within housing 10. This partial vacuum pressure draws material into inlet chamber 46. As the rotating gear teeth 24 mesh together, an increase in pressure occurs and the material is carried in voids 36 between gear teeth 24 and housing 10 to outlet chamber 48. More specifically, material received in voids 36 facing inlet chamber 46 is simultaneously transported (1) upward by the clockwise rotation 42 of upper gear 12ᵤ and delivered to outlet chamber 48 and (2) downward by the counterclockwise rotation 44 of lower gear 12ₗ and delivered to outlet chamber 48. The seal formed by the intermeshing of gear teeth 24 in intermeshing region 38 maintains the differential pressure between the lower pressure inlet chamber 46 and the higher pressure outlet chamber 48.

Gear pump 2 forms a simple and economical pump. One advantage of gear pump 2 is that relatively few parts are employed, so the pump is relatively inexpensive to purchase and maintain. Also, gear pump 2 is highly reliable and exhibits good performance.

However, one problem with gear pump 2 is that a certain volume of material bleeds out of gear chamber 4. As shown in FIG. 7, Region #1 is effectively pinched off as upper gear 12ᵤ rotates. As rotation of upper gear 12ᵤ continues, Region #1 is reduced to the size of Region #2, which is approximately one-fourth the size of Region #1. This significant decrease in space must correspond to a decrease in volume of material contained within the space. Thus, a situation is created in which a small volume of material is trapped in Region #1 and then compressed into a smaller Region #2. The primary exit route for the compressed material is outwardly through the sides of the intermeshing gears in the direction of longitudinal axis 20, where there are small gaps or clearances to allow the gears to spin.

The process of squeezing material out the sides of the intermeshing gears exposes the material to high temperature, high pressure, and shear. These conditions change the properties of the material such that the material squeezed out of the sides of the intermeshing gears cannot be fully incorporated into the flow when it reenters the flow stream. Specifically, the material that was squeezed out of the sides of the intermeshing gears becomes segregated from the material flowing into inlet chamber 46 such that the overheated material gravitates toward the edges of inlet chamber 46 and outlet chamber 48.

Most prior art attempts to minimize the amount of material that is squeezed out the sides of the intermeshing gears entail modifying the amount of “wobble” in the gears. This can be effected by modifying the journal bearing clearances, the gear backlash, and the side clearances. By making these adjustments, the clearances through which the material is squeezed become smaller. Thus, these prior art attempts entail eliminating or reducing the size of the exit route. These prior art attempts have, however, been largely unsuccessful because they do not provide an alternative exit route.

It is, therefore, desirable to provide for use in a gear pump a gear whose shape and structure decreases the amount of processed material that is squeezed out of the sides of the intermeshing gears during operation of the gear pump.

### SUMMARY OF THE INVENTION

Preferred embodiments of a gear for use in a gear pump include an indentation or depression formed on one or both of the first and second sides of at least one of the multiple gear teeth of the gear. Each of the indentations is of sufficient size to allow material to flow into the indentation during rotation of the gear. During operation of the gear pump, material processed by the gear pump and trapped in Region #1 flows into the indentation. The indentation effectively connects Region #1 to the outlet chamber such that the trapped material flows out of Region #1 and into the outlet chamber during counterrotation of the upper and lower gears and the consequent compression of Region #1. By providing an alternate escape route for the trapped material, the gear decreases the amount of trapped material and thereby decreases the amount of material that is squeezed out the sides of the gears. Consequently, material flow within the gear pump is improved.

Additional aspects and advantages will be apparent from the following detailed description of preferred embodiments, which proceeds with reference to the accompanying drawings.

### BRIEF DESCRIPTION OF THE DRAWINGS

FIG. 1 is an isometric view of a prior art gear pump.

FIG. 2 is a side elevation view of the gear pump of FIG. 1.

FIG. 3 is a front elevation view of the gear pump of FIG. 1.

FIG. 4 is a sectional view taken along lines 4-4 of FIG. 3.

FIG. 5 is a sectional view taken along lines 5-5 of FIG. 1.

FIG. 6 is an isometric view of a prior art gear suitable for use in the gear pump of FIGS. 1-3.

FIG. 7 is an enlarged schematic view of the intermeshing gears of FIG. 5.

FIG. 8 is an isometric view of a gear including gear teeth having indentations on one of the first and second sides of each gear tooth.

FIG. 9 is a side elevation view of the gear of FIG. 8.

FIG. 10 is an enlarged sectional view taken along lines 10-10 of FIG. 9.

FIG. 11 is a schematic view of intermeshing gear teeth, each gear tooth of which includes indentations on one of its first and second sides.

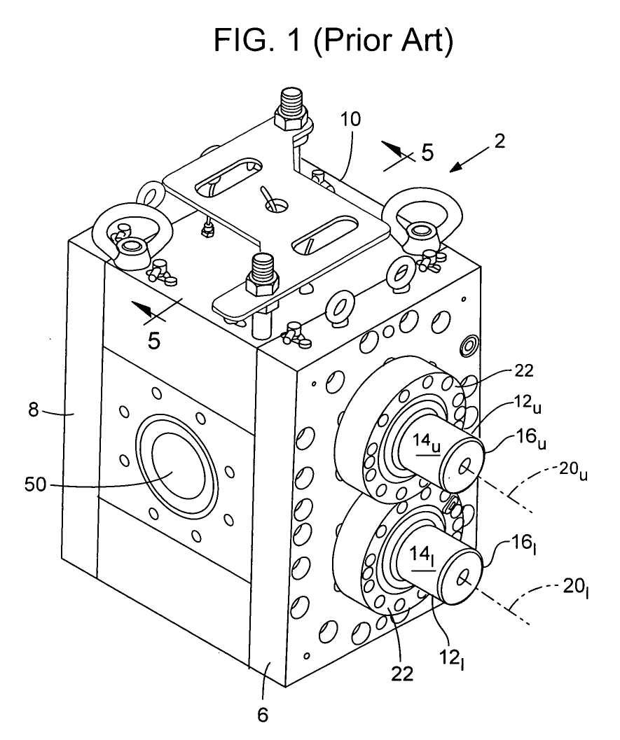

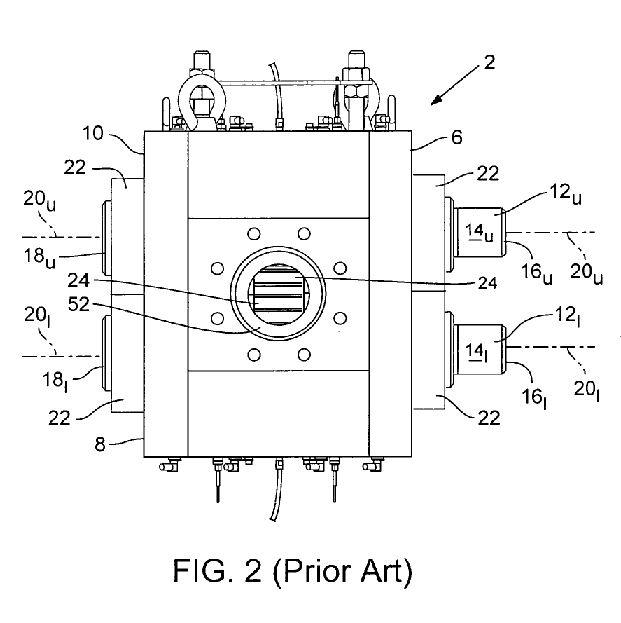

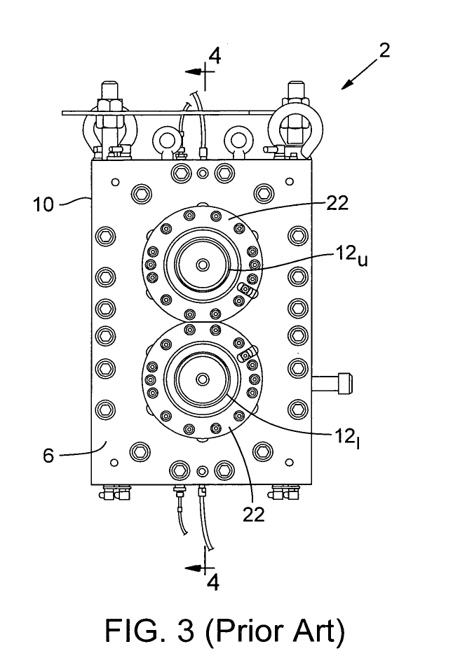

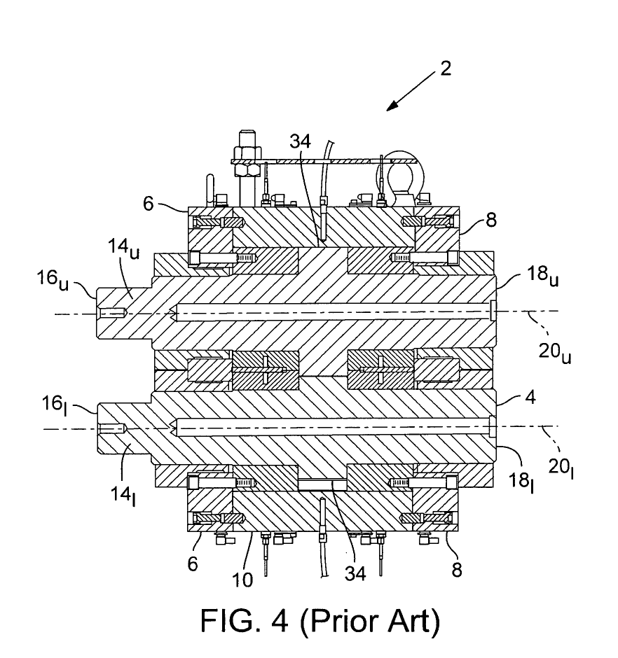

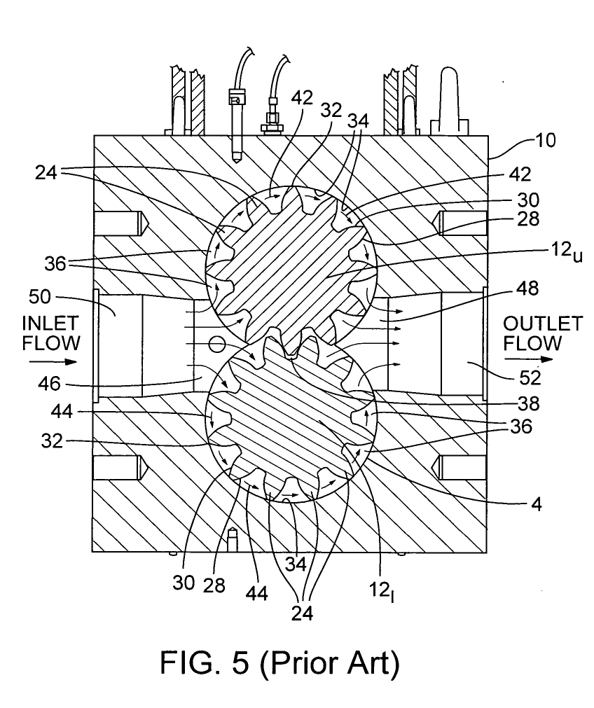

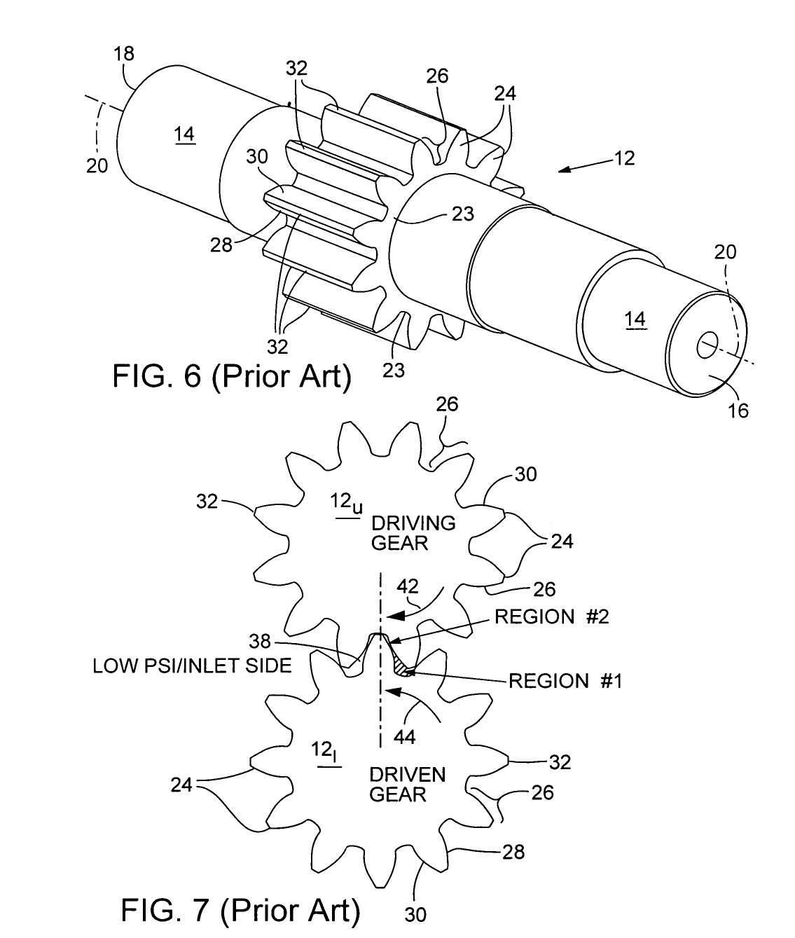

### DETAILED DESCRIPTION OF PREFERRED EMBODIMENTS

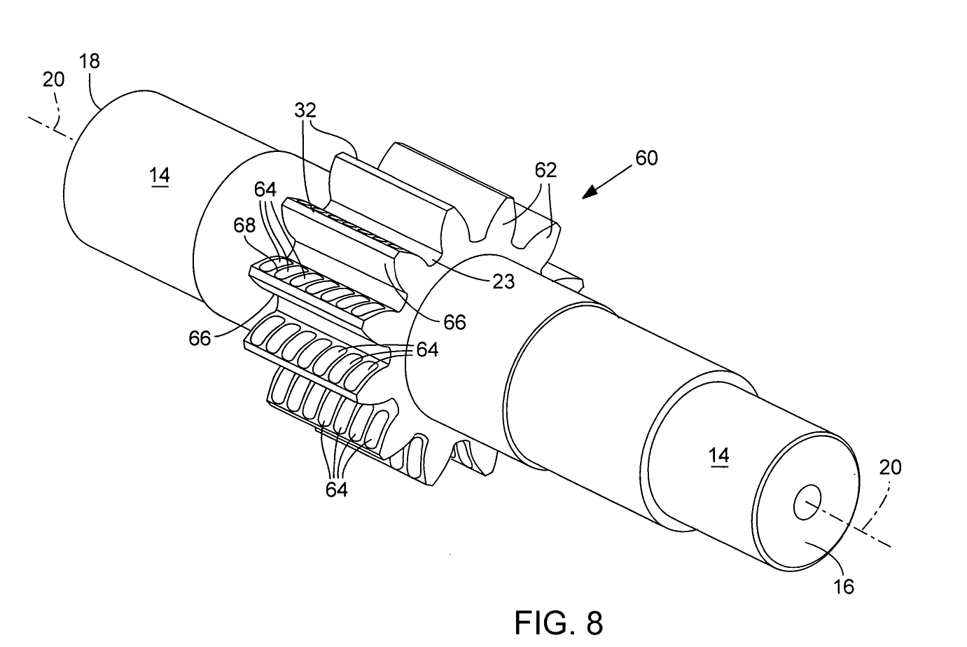

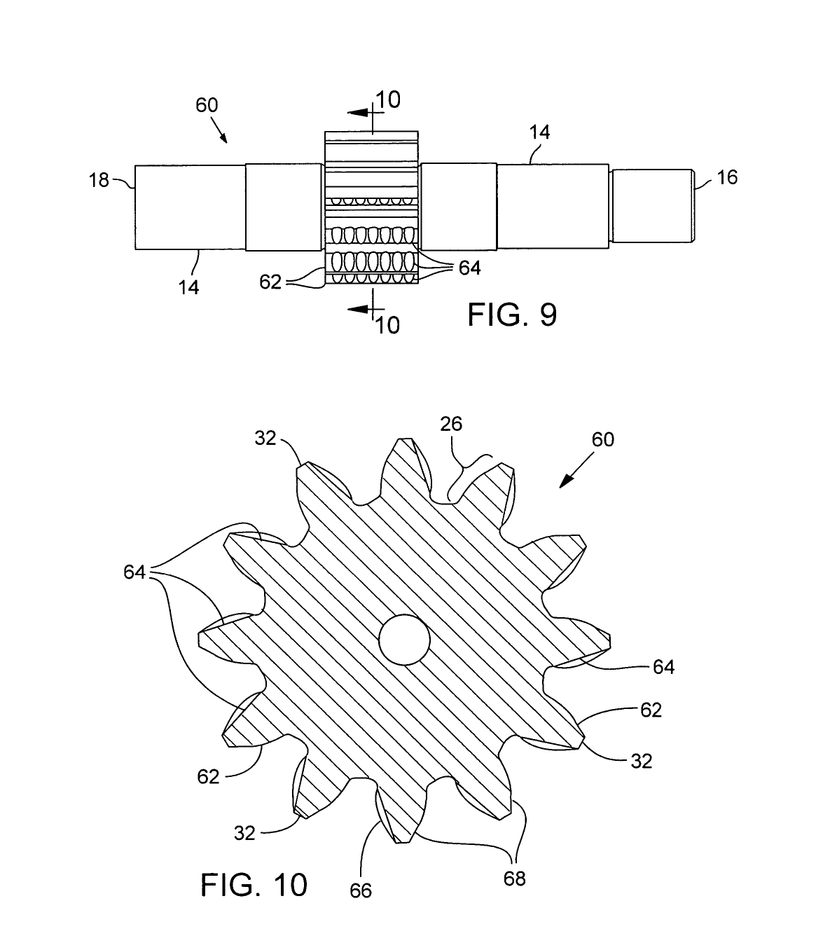

FIGS. 8-11 and the following description depict and describe a gear for use in a melt pump that processes a fluidic polymer material. This type of gear pump is merely exemplary, and the gear may be used in other types of gear pumps known to those skilled in the art.

Prior art attempts to reduce the volume of material that is squeezed out the sides of the intermeshing gears during operation of the gear pump entail eliminating or reducing the size of the exit route. As described above, these prior art attempts have been largely unsuccessful. The applicants have designed a “vented gear” having a shape and structure that provide an alternative exit route for the trapped material.

FIGS. 8, 9, and 10 show respective isometric, side elevation, and cross-sectional views of an exemplary preferred embodiment of a vented gear 60. Vented gear 60 has generally the same structure as that of gear 12, except that each elongated gear tooth 62 angularly spaced around shaft portion 14 includes multiple indentations or depressions 64 formed on one of first sides 66 and second sides 68. FIGS. 8-10 show an exemplary preferred embodiment in which indentations 64 are formed on second (trailing) side 68, but indentations 64 may be formed on either or both of first and second sides 66 and 68. Material processed in gear pump 2 flows into indentations 64 during operation of a gear pump in which vented gear 60 is housed. Indentations 64 on gear teeth 62 provide “venting” of gear 60 by creating an alternate flow path for the otherwise trapped material processed by the gear pump in which vented gear 60 is housed. Specifically, indentations 64 transport the otherwise trapped material into outlet chamber 48.

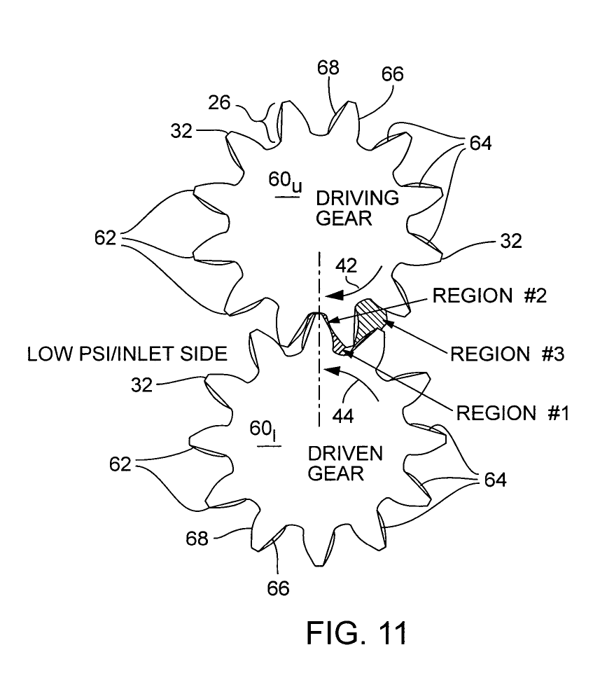

FIG. 11 is a cross-sectional view of an exemplary preferred embodiment of two intermeshing vented gears 60. Upper vented gear 60ᵤ is preferably the driving gear and is rotatably driven by a power source (not shown), such as a motor. Upper gear 60ᵤ rotates in a clockwise direction, as shown by directional arrow 42. Lower gear 60ₗ is the driven gear and rotates in a counterclockwise direction, as shown by directional arrow 44. Upper and lower gears 60ᵤ and 60ₗ are positioned such that indentations 64 are formed on first (leading) side 66 of gear teeth 62ₗ and on second (trailing) side 68 of gear teeth 62ᵤ. Thus, when gear teeth 62ₗ intermesh with gear teeth 62ᵤ in intermeshing region 38, indentations 64 on upper and lower gear teeth 62ᵤ and 62ₗ are adjacent to one another. This alignment facilitates full power transmission from upper (driving) gear 60ᵤ to lower (driven) gear 60ₗ without compromising contact pressures or angles.

Adjacent indentations 64 on upper and lower gear teeth 62ᵤ and 62ₗ effectively connect Region #1 to Region #3 such that, as rotation of upper and lower gears 60ᵤ and 60ₗ takes place, the material that is beginning to be compressed in Region #1 flows into Region #3. In prior art gear pumps, Region #1 is sealed off from Region #3, but adjacent indentations 64 in upper and lower gears 60ᵤ and 60ₗ create a flow channel through which compressed material may flow. Thus, instead of forcing the material in Region #1 to compress into the smaller volume of Region #2, the material in Region #1 flows into outlet chamber 48. In this way, indentations 64 in gear teeth 62 allow otherwise trapped material to escape from intermeshing region 38 to outlet chamber 48. By reducing the amount of material that is compressed during counter-rotation of upper and lower vented gears 60ᵤ and 60ₗ, vented gear teeth 62 reduce the localized energy input to the “trapped” material. Moreover, because less “trapped” material is squeezed out the sides of upper and lower gears 60ᵤ and 60ₗ, a reduced volume of material undergoes the undesirable material property changes described above. This reduction creates a more uniform flow of material exiting an improved gear pump 72 including upper and lower vented gears 60ᵤ and 60ₗ. Further, the use of upper and lower vented gears 60₀ and 60ₗ improves distribution of energy across the width of upper and lower vented gears 60ᵤ and 60ₗ.

Skilled persons will appreciate that improved gear pump 72 can be arranged to form various alternative embodiments. In a first alternative embodiment, lower vented gear 60ₗ is the driving gear and upper vented gear 60ᵤ is the driven gear. In a second alternative embodiment, upper vented gear 60ᵤ rotates in a counterclockwise direction and lower vented gear 60ₗ rotates in a clockwise direction. In a third alternative preferred embodiment, vented gear 60 is mated to an unvented gear 12. In this third alternative embodiment, the alternate flow path remains the same; however, the size of the flow path is reduced. Vented gear 60 may be either the driving gear or the driven gear.

FIGS. 8-10 show an embodiment of gear 60 in which each gear tooth 62 includes seven indentations 64, but this number may be adjusted based on the viscosity of the material being processed and the intended application. Each vented gear 60 preferably includes from two to thirty gear teeth 62, and more preferably from ten to twenty gear teeth 62, on each shaft portion 14. Vented gear 60 is preferably formed of a hard material, such as tool steel or steel alloy, and may be coated with a hardening material. Although the preferred embodiments are shown using spur gears, the invention can be practiced on other gear forms, including helical or herringbone.

Although the shape, depth, number, and size of indentations 64 can be adjusted based on the viscosity of the material and the intended application, indentations 64 preferably extend across the full width of each gear tooth 62 to create a more uniform material flow. Indentations 64 shown in FIGS. 8 and 10 are scallop-shaped, but the shape of indentations 64 can be adjusted based on the specific pumping application and manufacturing method for which gear teeth 62 will be used.

The exemplary vented gear 60 shown in FIGS. 8-10 includes multiple indentations 64 in second (trailing) side 68 of each gear tooth 62. In a first alternative preferred embodiment, each gear tooth 62 includes a single indentation 64 that may be, for example, an elongate indentation 64 that extends along the width of gear tooth 62. In a second preferred alternative embodiment, only some or one of gear teeth 62 includes one or more indentations 64. In a third alternative preferred embodiment, some, one, or each gear tooth 62 includes one or more indentations 64 formed on each of first and second sides 66 and 68. In this third alternative embodiment, indentations 64 on first side 66 can be either symmetrical or asymmetrical to indentations 64 on second side 68.

Vented gear 60 may be used in any of a variety of pumping applications, such as applications in which the material being processed has a high viscosity or is highly sensitive, such as, for example, in the polymer extrusion or food industries. Vented gear 60 may also be implemented in any parallel-shaft power transmission gear application. Alternatively, gear 60 may be used in a dual-extended and dual-driven gear pump in which both gears are independently driven such that there are no direct contact or power transmission forces between the upper and lower gears. In an embodiment in which each of the gears in the dual-extended and dual-driven gear pump is a vented gear 60, upper and lower gears 60ᵤ and 60ₗ can include indentations 64 on both or either of first or second sides 66 and 68 of gear tooth 62. Although this embodiment exhibits decreased pump efficiency, it is especially useful for processing highly sensitive materials.

Changing the gear profile is an unconventional approach to addressing the problem of limiting the amount of material that is squeezed out the sides of the gears, in part because pump efficiency is generally a goal of pump design, and the formation of indentations 64 in gear teeth 62 results in a slight decrease in pump efficiency (less than about 5 percent). However, the applicants have found that the slight decrease in pump efficiency is outweighed, or offset, by the various advantages described above.

It will be obvious to those having skill in the art that many changes may be made to the details of the above-described embodiments without departing from the underlying principles of the invention. The scope of the present invention should, therefore, be determined only by the following claims.

1. In a gear pump that processes material and includes a gear having a shaft portion with opposite first and second ends and a longitudinal axis about which the shaft portion rotates, the gear including multiple elongated gear teeth positioned between the first and second ends, extending radially outwardly from the longitudinal axis, and angularly spaced around the shaft portion, an improvement comprising:
the multiple elongated gear teeth each including first and second sides; and
an indentation formed in one of the first and second sides of one of the gear teeth, the indentation being of sufficient size to allow material to flow into the indentation during rotation of the gear, thereby facilitating more uniform material flow within the gear pump.

2. The gear pump of claim 1, in which the side in which is formed an indentation includes multiple indentations.

3. The gear pump of claim 1, in which each of the multiple elongated gear teeth includes an indentation.

4. The gear pump of claim 3, in which each one of all of the multiple elongated gear teeth includes multiple indentations.

5. The gear pump of claim 1, in which the other of the first and second sides includes an indentation of sufficient size to allow material to flow into the indentation during rotation of the gear.

6. The gear pump of claim 5, in which the other side of the first and second sides includes multiple indentations.

7. The gear pump of claim 5, in which each of the multiple elongated gear teeth includes the indentation in the other of the first and second sides.

8. The gear pump of claim 7, in which each one of all of the multiple elongated gear teeth includes multiple indentations in each of the first and second sides.

9. The gear pump of claim 1, in which the gear constitutes a first gear and further comprising a second gear having multiple elongated gear teeth each having first and second sides, the first and second gears aligned such that the elongated gear teeth of the first gear intermesh with the elongated gear teeth of the second gear and at least one of the elongated gear teeth of the second gear includes an indentation formed in one of the first and second sides.

10. The gear pump of claim 9, in which one of the first and second sides of each of the multiple elongated gear teeth of the first gear includes multiple indentations, and in which one of the first and second sides of each of the multiple elongated gear teeth of the second gear includes multiple indentations.

11. The gear pump of claim 10, in which both of the first and second sides of the multiple elongated gear teeth of the first and second gears include multiple indentations.

12. The gear pump of claim 11, in which both of the first and second sides of all of the multiple elongated gear teeth of the first and second gears include multiple indentations.

13. A gear for use in a gear pump, comprising:
a shaft portion having opposite first and second ends and a longitudinal axis about which the shaft portion rotates;
multiple elongated gear teeth that extend radially outwardly from the longitudinal axis, are positioned between the first and second ends, and are angularly spaced around the shaft portion; and
the multiple elongated gear teeth each including first and second sides, and in at least one of the first and second sides is formed an indentation of sufficient size to allow material to flow into the indentation during rotation of the gear, thereby facilitating more uniform material flow within the gear pump.

14. The gear of claim 13, in which the side in which is formed an indentation includes multiple indentations.

15. The gear of claim 13, in which each of the multiple gear teeth includes an indentation.

16. The gear of claim 15, in which each one of all of the multiple elongated gear teeth includes multiple indentations.

17. The gear of claim 13, in which the other of the first and second sides includes an indentation of sufficient size to allow material to flow into the indentation during rotation of the gear.

18. The gear of claim 17, in which the other side of the first and second sides includes multiple indentations.

19. The gear of claim 17, in which each of the multiple gear teeth includes the indentation in the other of the first and second sides.

20. The gear of claim 19, in which each one of all of the multiple elongated gear teeth includes multiple indentations in each of the first and second sides.
